(19) United States
(12) Patent Application Publication
(10) Pub. No.: US 2024/0235815 A1
(43) Pub. Date: Jul. 11, 2024

(54) SYSTEMS AND METHODS FOR CONTINUOUS GENERATION AND MANAGEMENT OF EPHEMERAL CRYPTOGRAPHIC KEYS

(71) Applicant: Qwerx Inc., Vienna, VA (US)

(72) Inventors: Mark Pecen, Waterloo, CA (US); John Ellingson, Haymarket, VA (US)

(21) Appl. No.: 18/110,180

(22) Filed: Feb. 15, 2023

Related U.S. Application Data
(60) Provisional application No. 63/438,186, filed on Jan. 10, 2023.

(51) Int. Cl. H04L 9/06

(52) U.S. Cl. CPC H04L 9/0662; H04L 9/0631

(57) ABSTRACT

A cryptographic management key system is disclosed for providing secure communication in a cryptographic system. The cryptographic key management system includes a plurality of communication apparatuses under the control of a common control console, each communication apparatus being in communication with at least one source of dynamic random or pseudo-random information via the common control console, and communication paths among the plurality of communication apparatuses, said communication paths including a control plane, a random information plane and a data plane.

### PRIORITY

The present application claims priority to U.S. Provisional Patent Application No. 63/438,186 filed Jan. 10, 2023, the disclosure of which is hereby incorporated by reference in its entirety.

### BACKGROUND

The invention generally relates to data protection, cryptography and security architecture, and relates in particular to the control of cryptographic systems such as advanced encryption standard (AES) 256 bit encryption (AES-256).

The encryption standard AES-256 first appeared in 2001 in commercial implementations, and has long been accepted as a strong encryption standard by the public and private sector. As with other symmetric key modalities, it is inherently stronger than similar asymmetric key modalities. The standard however, has previously retained the inherent vulnerabilities of symmetric keys, specifically that the shared and stored key need to be protected from compromise. The cryptographic system itself is strong, but if the keys are stolen or obtained by social engineering, the security can be broken without breaking the cryptosystem itself.

Although the standard is highly effective in hiding information from potential attackers, an apparent weakness is the use of a shared secret key, which is common to both symmetric and asymmetric cryptosystems in use at present. This means that the primary attack vector to AES-256 is not breaking the cryptography, as this would require a very sophisticated supercomputer to spend 2.29×10³⁸ years. The more important issue is that keys can be stolen via the path of social engineering.

This is why attacks at present tend to avoid addressing the cryptographic primitives themselves, because these are considered highly effective, and generally a waste of time to attack directly, as they are likely to require large amounts of computing power and time. The modern approach for the 2020s is to steal the keys in one manner or another, e.g., social engineering or compensating a data center employee to deliver keys and certificates illegally. Because of the lack of trace records in most cases, many such breaches may not be detected for relatively long periods of time. Stolen credentials have been the cause of some of the costliest data breaches in recent years such as breaches at Equifax Inc., Yahoo! Inc. and the U.S. government. Further to this, it is estimated that stolen credentials have been used in at least 85% of recent phishing attacks, as social engineering attacks tend to be far simpler than attacks directly to the cryptosystem.

There remains a need therefore, for cryptographic systems that are better designed to reduce vulnerabilities and thwart attack.

### SUMMARY

In accordance with an aspect, the invention provides a cryptographic management key system for providing secure communication in a cryptographic system. The cryptographic key management system includes a plurality of communication apparatuses under the control of a common control console, each communication apparatus being in communication with at least one source of dynamic random or pseudo-random information via the common control console, and communication paths among the plurality of communication apparatuses, said communication paths including a control plane, a random information plane and a data plane.

In accordance with another aspect, the invention provides a key generation system for continuous generation of disposable cryptographic keys for an underlying cryptosystem. The key generation system includes at least one source of raw entropy that provides the source of information to generate random information or pseudo-random information, an entropy multiplexer that combines entropy from at least one entropy source; a key material loader that formats raw key material and loads it into a database, a key material database that stores entropy information that can be accessed randomly via index positions and its information shuffled relative to any other indexed position in the database, a key material management and synchronization system that performs as a system controller of a network system, a key material quantizer that quantizes the raw entropy from the database and formats it into an appropriate cryptographic key, and a payload data quantizer that formats and unformats payload data to and from the encryption and decryption units.

In accordance with a further aspect, the invention provides a method for producing ephemeral, disposable cryptographic keys in an underlying cryptographic system. The method includes selecting one or more sources of random information or pseudo-random information, multiplexing the random information or pseudo-random information in a pre-defined or arbitrary manner, formatting the random information or pseudo-random information for storage in a random access database, shuffling and/or re-indexing the information in the random-access database relative to its index positions, formatting the shuffled random information from the database to form a key and an initialization vector, sending the formatted key material to the cryptosystem; selecting the format for upper layer payload data packets, disassembling the payload packet into smaller packets that can be transported by the cryptosystem, and assembling data payload packets arriving from the cryptosystem into decrypted payload packets that are then passed to the upper layers of the system.

### BRIEF DESCRIPTION OF THE DRAWINGS

The following description may be further understood with reference to the accompanying drawings in which:

FIG. 1 shows an illustrative diagrammatic functional view of a system in accordance with an aspect of the present invention;

FIG. 2 shows an illustrative diagrammatic network view of a system in accordance with an aspect of the present invention;

FIG. 3 shows an illustrative diagrammatic view of an information control system in a cryptographic management key system in accordance with an aspect of the present invention;

FIG. 4 shows an illustrative diagrammatic view of an entropy multiplexer signaling packet in the system of FIG. 3;

FIG. 5 shows an illustrative diagrammatic view of an entropy multiplexer output packet in the system of FIG. 3;

FIG. 6 shows an illustrative diagrammatic view of entropy multiplexer processing steps in an entropy multiplexer in the system of FIG. 3; and

FIG. 7 shows an illustrative diagrammatic view of key changes per octet data packet periods in the system of FIG. 3.

The drawings are shown for illustrative purposes only.

### DETAILED DESCRIPTION

In accordance with various aspects, the invention provides a system and method with an apparatus for 1) further improving and securing underlying cryptosystems and 2) eliminating the attack vector associated with stolen keys and other related credentials such as certificates.

Predictability and determinability of components of the entire encryption method provide pathways of attack. By eliminating components such as the exchange or storage of actual keys and the predictable use of known or predictable key or bit size, these pathways are reduced or eliminated entirely. The introduction of variability in the remaining system components increases the level of difficulty facing the attacker. Although the below example uses the AES-256 cryptosystem, systems and methods of the invention apply to the construction of keys of many other underlying cryptosystems.

Disclosed herein is an approach that eliminates the storage and exchange of keys while retaining the strength of symmetric and asymmetric key cryptosystems in accordance with an aspect of the present invention. The system in accordance with an aspect has the following properties. First, the keys produced are built from ephemeral key material, basically raw entropy, and are therefore dynamic and only exist when being used. Second, the keys are never stored anywhere. Only raw information from which keys are assembled in the moment of their use is stored. That information is of no use to an adversary while in storage. These can be viewed as disposable crypto keys. Third, another property is the introduction of the time element, and specifically the ability to assemble and use keys from raw entropy, and which may be changed periodically, e.g., many times per second. This further assures against the so-called “harvest and decrypt” attack where the attacker simply saves the encrypted data stream and attempts to decrypt it over time. Fourth, the keys themselves are never exchanged and only information that enables identical keys to be assembled many times a second is exchanged and that information is of a nature that it can be exchanged in the clear. Fifth. the keys are never exposed to an adversary and never exist where they must be protected. Because they can change many times a second and multiple keys can be used for both authentication and encryption, the challenge for an attacker is of such complexity that it is beyond solution in the life of the universe.

By stripping away the storage and exchange of keys, the modality is simpler and lighter weight than the current modality and easier to implement, but significantly less vulnerable to attack. The approach addresses certain attack vectors that have become common in recent years. The novelty of the current invention is in the removal of inherent vulnerabilities in the current architecture and method of application of underlying cryptographic system.

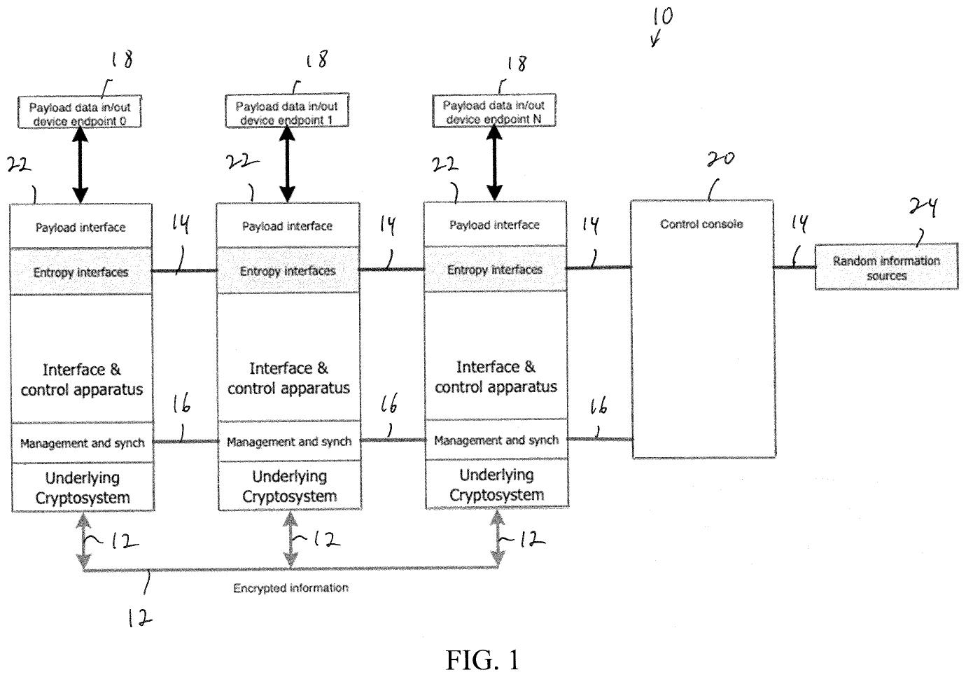

FIG. 1 shows a functional view of a system 10 in accordance with an aspect of the invention that includes the data plane 12, the entropy plane 14 and the control plane 16, in which N communication endpoints 18 are connected to each other and to a control console 20 that manages the acquisition and transfer of random information and controls the key management and synchronization system at each node 22. The encrypted information is communicated via the data plane with each node 22 via an underlying cryptosystem of each node. Each node 22 also includes a management and synchronization system that communicates with the control console via the control plane 16, as well as its own interface and control apparatus. Each module 22 also includes an entropy interface that communicates via the entropy plane 14 with the control console 20, which in turn is in communication with random information sources 24, an in particular, dynamically changing sources of random or pseudo-random information. Each node 22 further is in communication with each communication endpoint 18 via a payload interface.

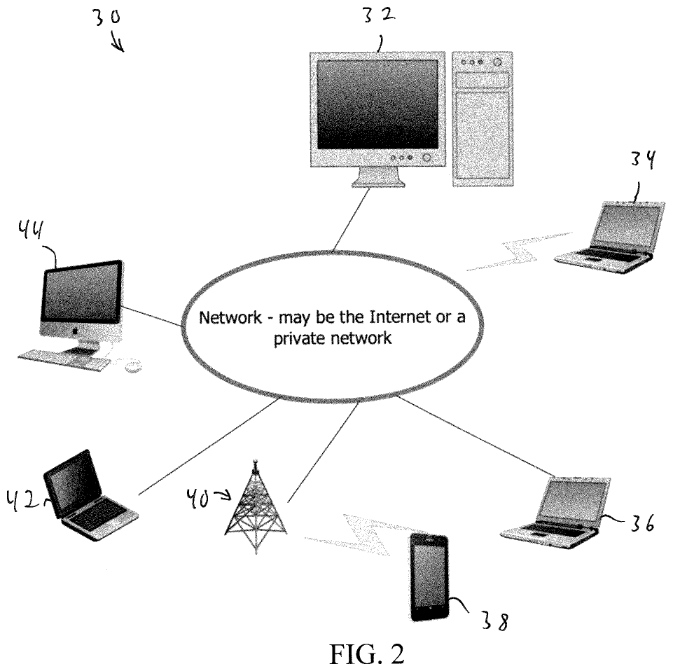

A network view of the system is shown at 30 in FIG. 2, which includes any of desktop computers 32, 44 connected to a network 46, laptop devices 36, 42 connected to the network 46 or connected (as shown at 34 as a laptop or personal communication device 38) via anther network such as cellular network 40 to the network 46. The control console (20 of FIG. 1) manages the provisioning, distribution of key material, indexing, synchronization and eventual de-provisioning of various devices on the network, or having access to the network via e.g., the cellular gateway. The network 46 may be the Internet or any local or private network. Clients may securely communicate among themselves once provisioned by the control console.

Each of the multiple communication apparatuses may be connected to a common medium to carry the signaling information, cipher stream and random information, or each of these may be carried by separate logical and/or physical media. In the network view of FIG. 2, heterogeneous devices may all communicate securely. Each communication apparatus is in communication with at least one source of random or pseudo-random information via the common control console 20. Each of the communication paths of the plurality of communication apparatuses include the data plane 12, the entropy plane 14 and the control plane 16.

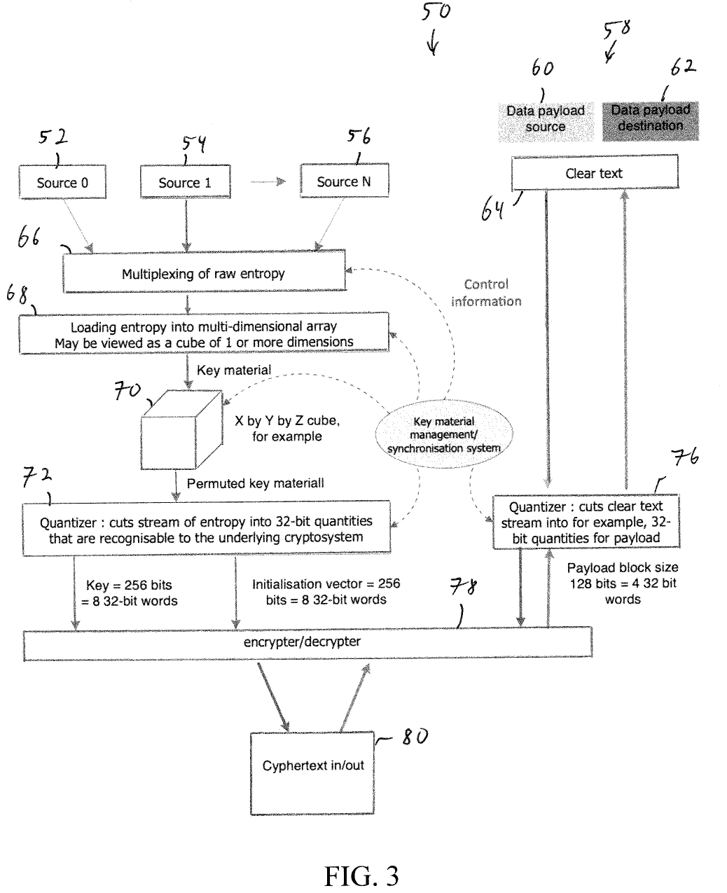

FIG. 3 shows an information control system 50 in a cryptographic management key system in accordance with an aspect of the present invention. The information control system 50 provides an information control process that involves receiving entropy material from entropy source 52, 54, 56 and is provided to a multiplexing entropy module 66 that provides for multiplexing of the raw entropy material from the entropy sources 52, 54, 56. The entropy sources 52, 54, 56 are, for example, dynamically changing sources of random and pseudo-random information. Data is communicated at 58 from data payload sources 60 and to data payload destinations 62 via a clear text module 64. The output of the multiplexing entropy module 66 is provided to the key material loader 68 that loads entropy source material into a multi-dimensional database 70 that may be viewed as a cube of one or more dimensions. Permeated key material is provided by the database 70 to a key material quantizer 72 that cuts streams of entropy into, for example, 32-bit quantities that are recognizable by the underlying cryptosystem. A key material management/synchronization system 74 is in communication with the multiplexing entropy module 66, the loading entropy module 68, the key material quantizer 72 and a payload data quantizer 76 that receives data from the data payload source 60 via the clear text module 64 and provides data to the data payload destination 62 via the clear text module 64. The key material quantizer 72 and the payload data quantizer 76 communicate with an encrypter/decrypter module 78, which provides encrypted data to and from a cyphertext in/out module 80. In particular, the key material quantizer 72 provides to the encrypter/decrypter module 78 a key of, for example, 256 bits as eight 32-bit words as well as an initialization vector of, for example, 256 bits as eight 32-bit words. The payload data quantizer 76 communicates with the encrypter/decrypter module 78 via payloads of block size, for example, of 128 bits as four 32-bit words.

The apparatus shown in FIG. 3 is symmetric, and therefore the same key material is used in each direction of the communication link. The purpose and operation of each component in FIG. 3 are as follows. The one or more entropy sources 52, 54, 56 provide at least on such source of random information used in the construction of cryptographic keys. The entropy source or sources may be e.g., quantum random number generators (QRNGs) or other sources of random information. The entropy multiplexer 66 combines the random information from more than one entropy sources in a time-division manner, e.g., using fixed or variable 1) bit quantity and 2) sampling periods. The key material loader 68 formats the key material and loads it into the multi-dimensional array 70, which again may be viewed as a cube in three dimensions or other such database. The key material data are loaded in such a way so as to enable the shuffling of its relative position on defined boundaries definable by indexing. The indices may be shuffled as well as the index boundaries. The key material database 70 is the primary data store of key material, which may be shuffled, synchronized and distributed by the key material management and synchronization system.

The key material management and synchronization system 74 performs the distribution of key material databases and periodic distribution of indexing information to the relevant parties among whom secure communication may be initiated, as well as the methods of synchronization among the communicating peers. It may periodically shuffle the index positions in the key material database and distribute such index information to the relevant parties. It goes beyond the prior art by providing control of services as 1) the multiplexing of raw entropy, 2) loading the combined entropy into the multi-dimensional database, 3) controlling the quantization boundaries of the raw permuted key material, controlling the generation (or not) of the initialization vector data and 4) controlling the bit/word boundaries of the payload data to ensure compliance to the transmissible size and formatting requirements of the underlying network.

The key material quantizer 72 receives the permuted key material, as indexed and shuffled by the key material management and synchronization system is then broken down into bitwise quanta that the underlying encryption/decryption system can make use of, comprising for example, 1) a 256-bit key and 2) a 256-bit initialization vector, which ensures that any new data which are encrypted using the same key do not result in the same cyphertext or clear text (in the case of decryption). The payload data quantizer 76 provides that payload data are packed (in the case of encryption) on 128-bit boundaries or unpacked from 128-bit quantities and assembled into data packets that the system components in the subsequent layers understand, e.g., transport layer packets such as Transmission Control Protocol (TCP) or User Datagram Protocol (UDP) packets that may have a payload of 1500 octets. The IP transport layer is used in this example, but the invention may be deployed at other logical positions in the network.

The encryption/decryption module 78 may be implemented in software, firmware, custom hardware Application Specific Integrated Circuits (ASICs) and/or Field Programmable Gate Arrays (FPGA) devices among other types of architecture. It is symmetric, which means that it functions bi-directionally as an encryption and decryption service using the same parameters in both directions. Again, FIG. 3 shows a basic apparatus for implementation of disposable cryptographic keys.

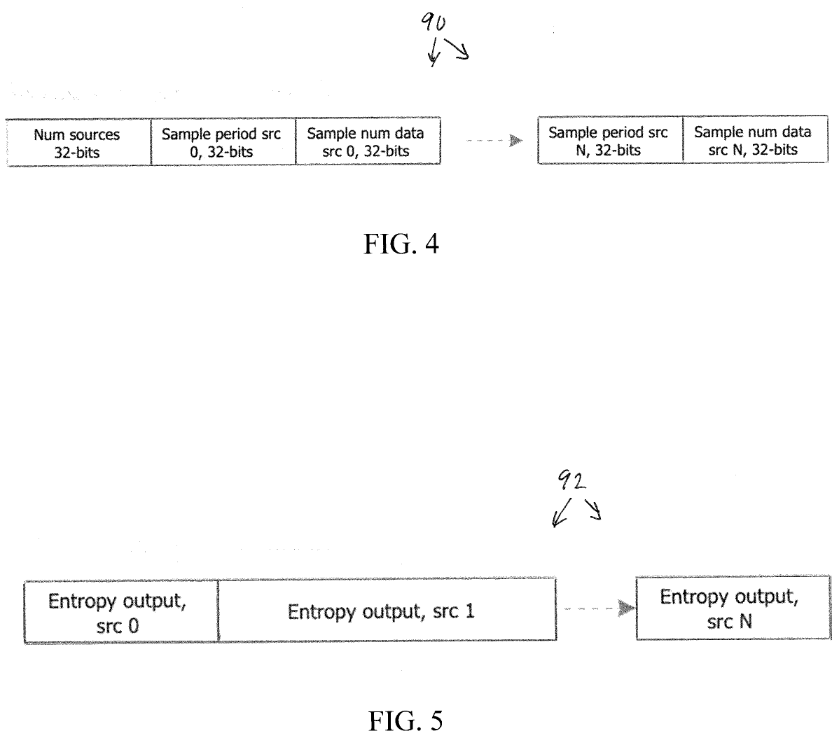

With reference to FIG. 4, the entropy multiplexer receives raw random information from one or more entropy sources. In the case of a single entropy source, no multiplexing occurs, but the multiplexer samples the information from the entropy source for a time period defined by a command from the key material management and synchronization system (KMSS) 74 (of FIG. 3). The KMSS 74 may instruct the multiplexer to sample for 1) a specific period of time, or 2) a specific number of octets of entropy information. If more than one entropy source is present and active, the KMSS 74 shall additionally specify the identifier of each source, as well as the specific period of time over which to sample that source or specific number of octets of entropy to receive from each source. The resulting output shall be a string of octets in a format usable by the key material loader 68 (of FIG. 3) in the manner of FIG. 4.

FIG. 4 shows at 90 an entropy multiplexer signaling packet, which includes the values num sources, sample period src and sample num data. The values num sources represent the total quantity of entropy sources sampled. The values sample period, src 0 through src N represents the sampling period, which may represent seconds, ms, microseconds or other quantities, depending on the implementation. The values sample num data, src 0 through src N represents the number of data to receive from each entropy source, and may represent number of bits, octets, or other quantities, depending on implementation. The above quantities may be expressed, for example, as 32-bit quantities. Although the signaling packet may imply a certain order of entropy sources which to read, the KMSS may construct a hopping-list that specifies the sequence of each entropy source to determine if there are more than one entropy sources.

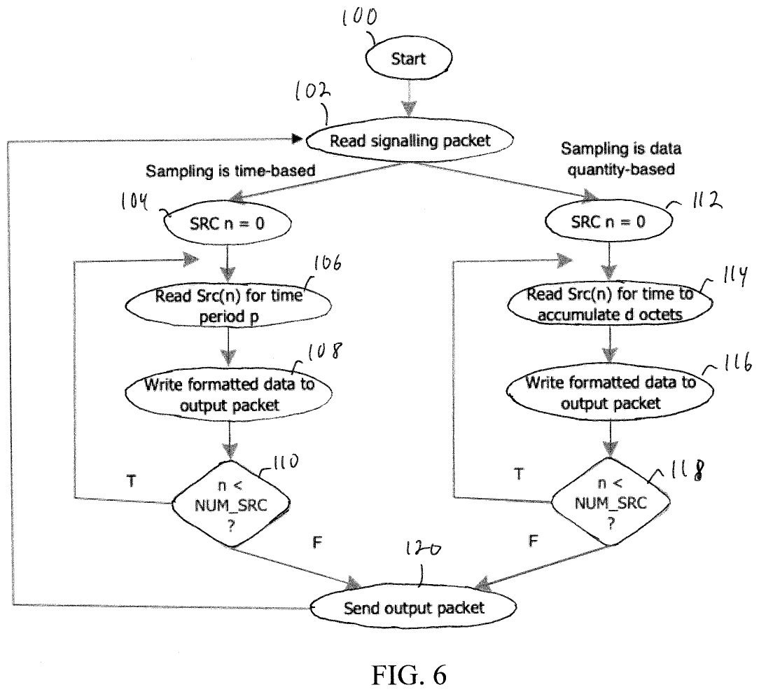

With reference to FIG. 5, the entropy multiplexor output packet 92 includes entropy output src 0 . . . entropy output src N, which represents the arrangement of entropy to be passed to the key material loader 68. The above quantities may be expressed in a manner that is implementation dependent, such as bits, octets, 32-bit words or otherwise. The order of the output data is instructed by the KMSS and is not necessarily in order from 0 through N. FIG. 5 shows the entropy multiplexer output packet, and FIG. 6 shows the entropy multiplexer process.

With reference to FIG. 6, the process begins (step 100) with the system reading the signaling packet. The signaling packet is read and parameters are scanned. These parameters include Opcode (in data acquisition mode), the number of entropy sources, the sampling period, and the sampling quantity. The signaling packet is then read (step 102), and the sampling may be either time-based or quantity-based. Where the sampling is time-based, the system sets the source count (scr n) equal to zero (step 104), then reads the source (n) for a time period (step 106) and writes formatted data to an output packet (step 108). The process repeats until the upper limit of the count (n) is reached (step 110). Where the sampling is quantity-based, the system sets the source count (scr n) equal to zero (step 112), then reads the source (n) for a time to accumulate a desired set (d) of octets (step 114) and writes formatted data to an output packet (step 116). The process repeats until the upper limit of the count (n) is reached (step 118). Either way, the system then sends the output packet to database 70 (step 120).

The key material loader 68 therefore receives formatted entropy material from the multiplexer and loads it into the key material matrix database 70. This is done under the control of the key material management and synchronization system 74, which may additionally shuffle the indices. The key material loader 68 receives a control packet from the KMSS 74 and performs the operation associated with the received opcode.

The key material database 70 may be viewed as a multi-dimensional cube, or other such entity, where the important feature is that the information in the database may be re-indexed and shuffled. This means that external references to the index shall be able to randomly access any octet, word or other quantity of data and also that the relationship of the data elements may be shuffled, which may mean a partial or complete re-ordering of the information in the database relative to the indices.

Additional functionality of KMSS 74 include the following. The KMSS 74 may be external to all communication endpoints. Its purpose is to coordinate the activities of each network element in the entire system. This includes control of the entropy multiplexer 66, control of the key material loader 68, shuffling of the key material databases indices 70, control of the key material quantizer 72, and control of the payload data quantizer 76. The entropy multiplexer 66 selects the desired number of entropy sources and data acquisition mode. The key material loader 68 sets the data length boundaries for insertion of key material into database. The key material databases indices 70 re-orders of some or all of the key material stored as entropy quanta in the database, which may be done directly, or indirectly by re-ordering the indexing. The key material quantizer 72 controls the formatting of an actual non-reusable i) encryption key and ii) initialization vector, in the format that is consistent to the requirements of the underlying cryptosystem. The payload data quantizer 76 sets the data boundaries in bits or octets for payload data coming in or out of the cryptosystem.

The quantizers manage the packeting of the information. In particular, the key material quantizer 72 formats the entropy from the database into actual keys and initialization vectors, as per the specification of the underlying cryptosystem. For example, each key and each initialization vector may comprise 256 bits. The resulting formatted keys and initialization vectors are subsequently sent to the cryptosystem. The payload data quantizer 76 element sets the boundaries of payload quantity for a given encode or decode operation. In addition, it i) disassembles packets arriving from upper layers of the system stack (e.g., payload area of User Datagram Protocol (UDP) packets) into packets formatted for the underlying cryptosystem specifications and ii) assembles packets arriving from the decryption unit into upper-layer formatted data packets, including the assembly of decrypted payload area and any required clear text headers.

In accordance with various aspects, therefore, the invention provides a secure communication system including a plurality of communication apparatuses under the control of a common control console, one or more sources of random information, sent to each communication apparatus, and connection of all elements by the control plane, random information plane and data plane. The connection among the network elements may be wireline, wireless, etc.

In accordance with other aspects, the invention provides an apparatus for continuous generation of disposable cryptographic keys for an underlying cryptosystem including any of the following elements: one or more sources of raw entropy provide the source of information to generate random information; an entropy multiplexer, which combines entropy from one or more entropy sources; a key material loader, which formats raw key material and loads it into a database; a key material database, which stores entropy information that can be accessed randomly via index positions and its information shuffled relative to any other indexed position in the database; a key material management and synchronization system, which performs as the master controller of the entire system; a key material quantizer, quantizes the raw entropy from the database and formats it into an appropriate cryptographic key; and a payload data quantizer, which formats and unformats payload data to and from the encryption and decryption units.

In such an apparatus the one or more entropy sources may comprise random information generators, implemented in a variety of ways. The one or more entropy sources may comprise one or more databases containing random information. The entropy sources may comprise one or more quantum random number generators. The underlying cryptosystem may be, for example, AES-256, RSA, or ECC.

In accordance with further aspects, the invention provides a method for producing ephemeral, disposable cryptographic keys including, for example, the following steps: selecting one or more sources of random information; multiplexing the random information in a pre-defined or arbitrary manner; formatting the random information for storage in a random-access database; shuffling and/or re-indexing the information in the random-access database relative to its index positions; formatting the shuffled random information from the database to form a i) key and ii) initialization vector; sending the formatted key material to the cryptosystem; selecting the format for upper layer payload data packets; disassembling the payload packet into smaller packets that can be transported by the cryptosystem; and assembling data payload packets arriving from the cryptosystem into decrypted payload packets that are then passed to the upper layers of the system.

In the method, the term cryptosystem may be replaced with specific, difference types of cryptosystems. The upper layer payload packets may refer to Transmission Control Protocol (TCP), User Datagram Protocol (UDP), or other Transport Layer data packets. The upper layer payload packets may refer to any other type of data packet format originating or terminating in any logical layer of the network.

In addition to performing the known functions of the key material management and synchronization system described by the prior art, the system adds 1) the multiplexing of raw entropy which may be generated from more than one source, 2) controlling the quantization boundaries of the raw permuted key material, 3) controlling the generation (or not) of the initialization vector data and 4) controlling the bit/word boundaries of the payload data.

As compared to existing systems using an underlying encryption/decryption method, a temporal element is added to the usage of the permuted key material extracted from the key material database, with the ability to set the periodicity of ephemeral key creation and usage. Keys are never stored, and only created before immediate use. Keys are never exchanged, only the index values are communicated among peers, which are meaningless to intruders. New keys may be manufactured at variable periodicity making them immediately useless to an intruder.

As further compared to existing system using an underlying encryption/decryption method, the synchronization of the indexing of key material database by the key material management and synchronization system among communicating peers eliminates the need for stored keys. Index synchronization means that all the peers know where to start constructing their keys and initialization sequences from the database of permuted key material. Therefore, no keys are stored before, or after their usage.

Systems and methods of various aspects of the present invention therefore are the i) introduction of a temporal component and ii) the fact that the keys are used once, and then discarded. The temporal component provides the ability to continually and rapidly generate sequential cryptographic keys that will be used over a very short period of time, e.g., 100 ms. This means that the information used for one key will never be used for another, identical key and that a random attack is unlikely to succeed, but in the event that it did succeed, there would be an extremely low probability of random attacks succeeding over the entire length of the message. With regard to the disposable keys, the fact that the keys are never used more than once, and furthermore never stored, means that there is no benefit to an attacker, because there is nothing relevant to steal or misuse by an attacker.

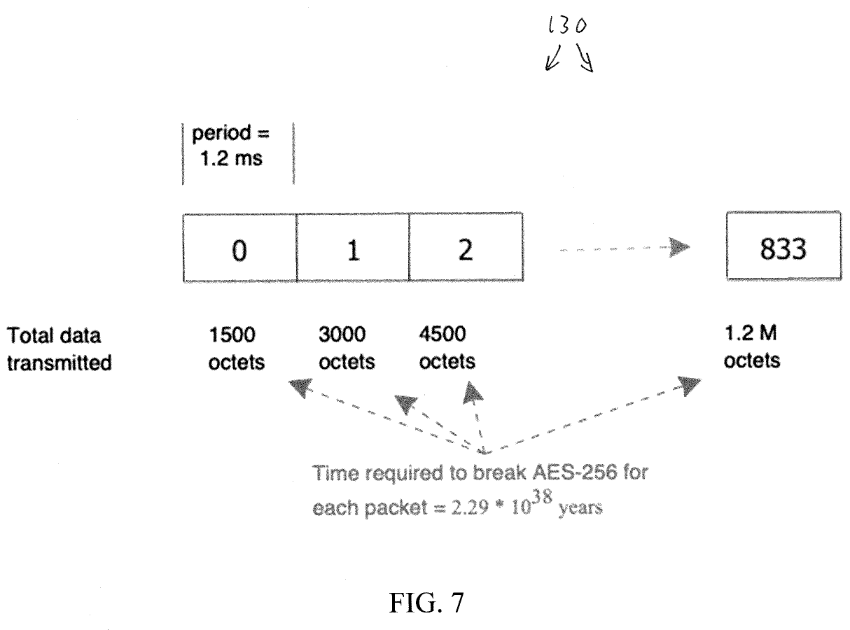

With reference to FIG. 7, a key may be changed every packet period (e.g., every 1.2 ms), which equates to the transmission of 1500 octets of information including all communication headers in accordance with an aspect of the invention. A transmission of a first, second, third, and final octet is shown diagrammatically at 130 in FIG. 7. Assume for example, that there is a communication link capable of interchanging 10 Mbits/sec=1.25 Moctets/second, and that the payload plus all communications headers=1500 octets. This means that in one second, the system can transmit 833 UDP packets. Now, for simplicity, assume that entire message is sent in one second, for a total of 1500*833=1.25 Moctets including all communication headers. This also means that the period to send one packet is 1.2 ms. Also assume that the system is using AES-256 as an underlying cryptosystem and that it requires a modern supercomputer to successfully attack each 1500 octet data packet. The time required therefore for an attacker to successfully decode all 833 data packets would be the sum of the time to decode a single one, because each 1500 octets of data are sent with a different key, or p<833:

$${T}_{d} = {\sum }_{p = 0}^{p = 833} 2.29 * {10}^{38} = 1.91 * {10}^{41} Years$$

So even if an attacker was fortunate to randomly guess an attack on one 1500 octet quantity of encrypted information, it would require 833 periods−1, making p=832

$${T}_{d} = {\sum }_{p = 0}^{p = 832} 2.29 * {10}^{38} = 1.9 * {10}^{41} Years$$

to decode the remaining data in the entire message, because each 1500 octet quantity would require 2.29*10³⁸ years to brute force attack. So, in one second of information transfer, the key has changed 833 times. This simple analysis reflects only the case of having the ability to decode all elements in the 833 periods. In reality, an attacker could learn something useful from partial decode of the message, although this would remain difficult.

In addition to the temporal element of rapidly changing keys, the fact that the keys are never stored and only used one time means that stealing useful keys is impossible, as there is nothing useful to steal because both (or all) endpoints have synchronized on the index of their respective (or central) databases containing key material.

Those skilled in the art will appreciate that numerous modifications and variations may be made to the above disclosed embodiments without departing from the spirit and scope of the present invention.

What is claimed is:

1. A cryptographic key management system for providing secure communication in a cryptographic system, said cryptographic key management system comprising:
a plurality of communication apparatuses under the control of a common control console, each communication apparatus being in communication with at least one source of dynamic random or pseudo-random information via the common control console; and
communication paths among the plurality of communication apparatuses, said communication paths including a control plane, a random information plane and a data plane, the random information plane being in communication with a multi-dimensional storage array of the control console, the multi-dimensional storage array for storing source entropy data that is indexed in discrete quantities, each discrete quantity being stored for single use.

2. The cryptographic key management system of claim 1, wherein the at least one source of dynamic random or pseudo-random information comprises random information generators.

3. The cryptographic key management system of claim 2, wherein the at least one source of dynamic random or pseudo-random information comprise random information generators include any of quantum random number generators and algorithmic random number generators and naturally chaotic non-linear random number generators.

4. The cryptographic key management system of claim 1, wherein the at least one source of dynamic random or pseudo-random information comprises one or more databases containing random information.

5. The cryptographic key management system of claim 1, wherein the at least one source of dynamic random or pseudo-random information comprises one or more quantum random number generators.

6. The cryptographic key management system of claim 1, wherein the underlying cryptographic system is the advanced encryption standard (AES).

7. The cryptographic key management system of claim 1, wherein the cryptographic system is Rivest-Shamir-Adelman (RSA).

8. The cryptographic key management system of claim 1, wherein the cryptographic system is elliptical curve cryptography (ECC).

9. A key generation system for continuous generation of disposable cryptographic keys for an underlying cryptographic system, said key generation system comprising:
at least one entropy source of raw entropy that provides the source of information to generate random information or pseudo-random information;
an entropy multiplexer that combines raw entropy from the at least one entropy source;
a key material loader that formats raw key material;
a key material database that receives the raw entropy from the key material loader and stores the raw entropy in discrete indexed quantities so that each indexed quantity can be accessed randomly via index positions and is information shuffled relative to any other indexed position in the database;
a key material management and synchronization system that performs as a system controller of a network system;
a key material quantizer that quantizes the raw entropy from the database and formats it into a cryptographic key for encryption and decryption units; and
a payload data quantizer that formats and unformats payload data to and from the encryption and decryption units.

10. The key generation system of claim 9, wherein the one or more entropy sources comprise random information generators.

11. The key generation system of claim 10, wherein the at least one entropy source comprise random information generators include any of quantum random number generators and algorithmic random number generators and naturally chaotic non-linear random number generators.

12. The key generation system of claim 9, wherein the at least one entropy source may comprise one or more databases containing random information.

13. The key generation system of claim 9, wherein the at least one entropy source may comprise one or more quantum random number generators.

14. The key generation system of claim 9, wherein the underlying cryptographic system is the advanced encryption standard (AES).

15. The key generation system of claim 9, wherein the underlying cryptographic system is Rivest-Shamir-Adelman (RSA).

16. The key generation system of claim 9, wherein the underlying cryptographic system is elliptical curve cryptography (ECC).

17. A method for producing ephemeral, disposable cryptographic keys in an underlying cryptographic system, said method comprising:
selecting one or more sources of random information or pseudo-random information;
multiplexing the random information or pseudo-random information in a pre-defined or arbitrary manner;
formatting the random information or pseudo-random information for storage in a random access database;
shuffling and/or re-indexing the information in the random-access database relative to its index positions;
formatting the shuffled random information from the database to form a key and an initialization vector;
sending the formatted key material to the underlying cryptographic system;
selecting the format for upper layer payload data packets;
disassembling the payload packet into sub-packets that are smaller than the upper layer payload packets and can be transported by the cryptosystem; and
assembling the data payload packets arriving from the underlying cryptographic system into decrypted payload packets that are then passed to the upper layer payload data packets.

18. The method of claim 17, wherein the underlying cryptographic system is the advanced encryption standard (AES).

19. The method of claim 17, wherein the underlying cryptographic system is Rivest-Shamir-Adelman (RSA).

20. The method of claim 17, wherein the underlying cryptographic system is elliptical curve cryptography (ECC).

21. The method of claim 17, wherein the upper layer payload packets may refer to Transmission Control Protocol (TCP), User Datagram Protocol (UDP), or other Transport Layer data packets.

22. The method of claim 17, wherein the upper layer payload packets may refer to any other type of data packet format originating or terminating in any logical layer of the network.
